(19) United States
(12) Patent Application Publication
(10) Pub. No.: US 2018/0173151 A1
(43) Pub. Date: Jun. 21, 2018

(54) OPC Drum Drive Solutions

(71) Applicant: Static Control Components, Inc., Sanford, NC (US)

(72) Inventors: Christopher Elton Nichols, Lillington, NC (US); Thomas Mathew Mitchell, Spring Lake, NC (US); Lawrence Dale Lewis, Myrtle Beach, SC (US)

(21) Appl. No.: 15/837,602

(22) Filed: Dec. 11, 2017

Related U.S. Application Data
(60) Provisional application No. 62/436,721, filed on Dec. 20, 2016.

(51) Int. Cl. G03G 15/00; F16D 1/10

(52) U.S. Cl. CPC G03G 15/757; F16D 2001/102; F16D 1/101

(57) ABSTRACT

A drive gear for a generally cylindrical imaging component. The drive gear includes a body for engaging the generally cylindrical imaging component having an axis of rotation, a drive portion extending out from body along the axis of rotation, wherein the drive portion comprises a plurality of pillars and narrows towards the axis of rotation of the drive gear as the distance from the end surface increases outward.

The present application claims the benefit of provisional U.S. Patent Application No. 62/436,721 filed Dec. 20, 2016 which is incorporated by reference herein in its entirety.

### BACKGROUND

The present invention generally relates to manufacturing, remanufacturing or repairing replaceable imaging components, and more particularly to apparatus and techniques for providing a drive gear for a drum or roller, such as an organic photo conductor (OPC) drum, for example, of a replaceable imaging cartridge adapted for holding marking material, such as toner.

In the imaging industry, there is a growing market for the remanufacture and refurbishing of various types of replaceable imaging cartridges such as toner cartridges, drum cartridges, inkjet cartridges, and the like. These imaging cartridges are used in imaging devices such as laser printers, xerographic copiers, inkjet printers, facsimile machines and the like, for example. Imaging cartridges, once spent, are unusable for their originally intended purpose. Without a refurbishing process these cartridges would simply be discarded, even though the cartridge itself may still have potential life. As a result, techniques have been developed specifically to address this issue. These processes may entail, for example, the disassembly of the various structures of the cartridge, replacing toner or ink, cleaning, adjusting or replacing any worn components and reassembling the imaging cartridge.

Laser printer toner cartridges are typically composed of two portions. One of these sections is the waste bin assembly which houses the OPC drum. The OPC may include a drive gear which engages with a printer drive member. See FIG. 1, for example, which shows a prior art gear 100 having a protruding nine point star that is cone or dome shaped with a circular hole through the center. During the remanufacturing of a laser printer toner cartridge, the OPC drum may need to be replaced due to the wear or damage of the OPC drum. The replacement OPC drum may include a replacement drive gear, or gear, attached to one end of the replacement OPC drum. The present invention provides for an improved replacement drive gear for the prior art drive gear 100.

### SUMMARY

In one aspect of the present invention, a drive gear for a generally cylindrical imaging component includes a body for engaging the generally cylindrical imaging component having an axis of rotation, a drive portion extending out from body along the axis of rotation, wherein the drive portion comprises a plurality of pillars and narrows towards the axis of rotation of the drive gear as the distance from the end surface increases outward, wherein the plurality of pillars is greater than three.

In another aspect of the present invention, the plurality of pillars is six pillars.

In another aspect of the present invention, the drive gear includes six pillars disposed in three groups of two pillars.

In another aspect of the present invention, the distance between the two pillars of each group is less than the distance separating pillars of different groups.

In another aspect of the present invention, the drive portion comprises an opening disposed at the center of the pillars along the axis of rotation.

In another aspect of the present invention, the drive gear further includes a deformable element disposed in the opening.

A more complete understanding of the present invention, as well as further features and advantages of the invention, will be apparent from the following detailed description and the accompanying drawings.

### BRIEF DESCRIPTION OF THE DRAWINGS

FIG. 1 shows a prior art drive gear; and

FIGS. 2-10 show perspective views of multiple embodiments of a drive gear in accordance with aspects of the present invention.

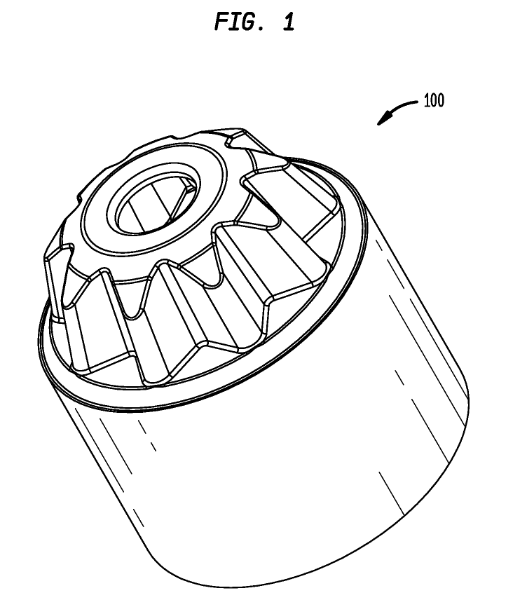

### DETAILED DESCRIPTION

The following detailed description of preferred embodiments refers to the accompanying drawings which illustrate specific embodiments of the invention. In the discussion that follows, specific systems and techniques for providing a drive gear for a drum or roller, such as an organic photo conductor (OPC) drum, for example, of a replaceable imaging cartridge adapted for holding marking material, are disclosed. Other embodiments having different structures and operations for the repair, remanufacture and operation of other types of replaceable imaging components and for various types of imaging devices, such as laser printers, inkjet printers, copiers, facsimile machines and the like, do not depart from the scope of the present invention.

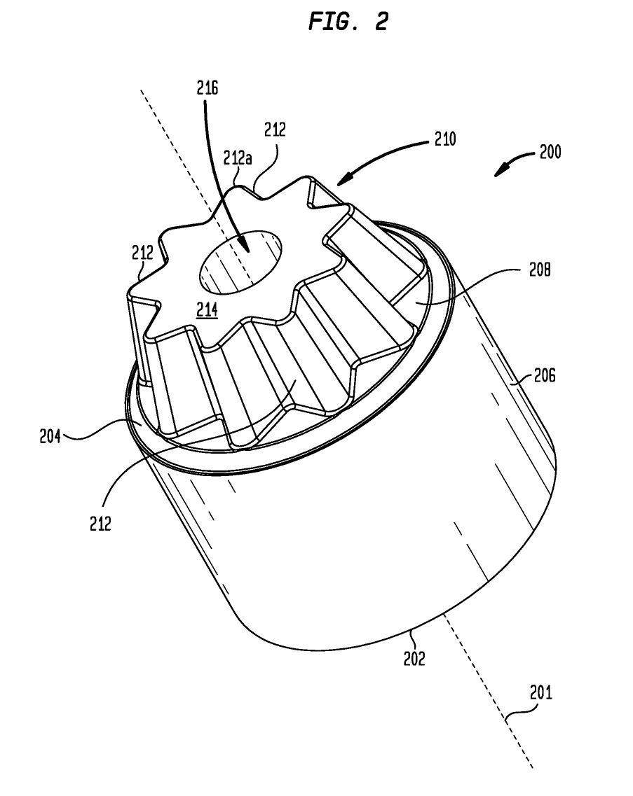

FIG. 2 shows a generally cylindrical drive gear 200 having an axis of rotation 201 in accordance with aspects of the present invention. One end 202 of the generally cylindrical drive gear 200 is adapted to be attached to a hollow roller or generally cylindrical imaging component, such as an OPC drum. The other end 204 of the drive gear 200 is adapted to engage the drive mechanism of a printer. The end 202 of the drive gear 200 includes a body 206 for engaging the generally cylindrical imaging component. The end 204 of the drive gear 200 includes an end surface 208. A drive portion 210 extends longitudinally outward from the end surface 208 and is shaped to engage a recess of the printer drive mechanism. The drive portion 210 comprises a plurality of connected pillars 212 and a top surface 214 having an opening 216. A circle circumscribing the tips of the pillars 212 has a greater diameter at the base of the pillars 212 (where the pillars 212 connect to the end surface 208) than at the top of the pillars 212. In other words, the drive portion 210 narrows or tapers towards the axis of rotation 201 of the drive gear 200 as the distance from the end surface 208 increases outward. Each of the pillars 212 may be generally triangular in shape with a vertex 212a of each triangular shaped pillar 212 being generally rounded. The number of pillars 212 may be nine or other suitable numbers for engaging the printer. The top surface 214 may be flat, inverted, or other suitable shape.

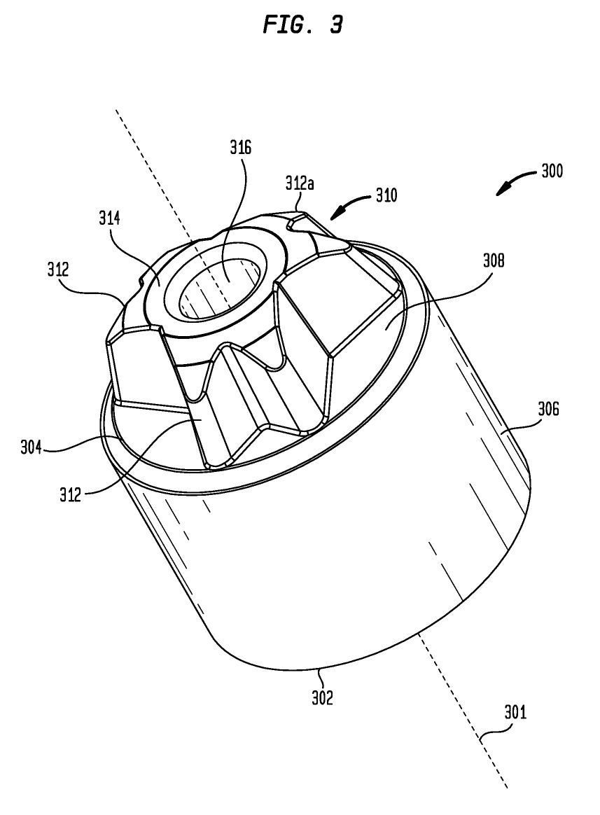

FIG. 3 shows a generally cylindrical drive gear 300 having an axis of rotation 301 in accordance with aspects of the present invention. One end 302 of the generally cylindrical drive gear 300 is adapted to be attached to a hollow roller or generally cylindrical imaging component, such as an OPC drum. The other end 304 of the drive gear 300 is adapted to engage the drive mechanism of a printer. The end 302 of the drive gear 300 includes a body 306 for engaging the generally cylindrical imaging component. The end 304 of the drive gear 300 includes an end surface 308. A drive portion 310 extends longitudinally outward from the end surface 308 and is shaped to engage a recess of the printer drive mechanism. The drive portion 310 comprises a plurality of connected pillars 312 and a top surface 314 having an opening 316. A circle circumscribing the tips of the pillars 312 has a greater diameter at the base of the pillars 312 (where the pillars 312 connect to the end surface 308) than at the top of the pillars 312. In other words, the drive portion 310 narrows or tapers towards the axis of rotation 301 of the drive gear 300 as the distance from the end surface 308 increases outward. Each of the pillars 312 may be generally triangular in shape with a vertex 312a of each triangular shaped pillar 212 being generally rounded. The number of pillars 312 may be six or other suitable numbers for engaging a portion of the recesses of the printer drive mechanism. The pillars 312 may be formed in groups, with three groups comprising two pillars 312. This distance between the pillars 312 of each group is less than the distance separating pillars 312 of different groups. The top surface 314 may at least partially slope upwards toward the opening 316.

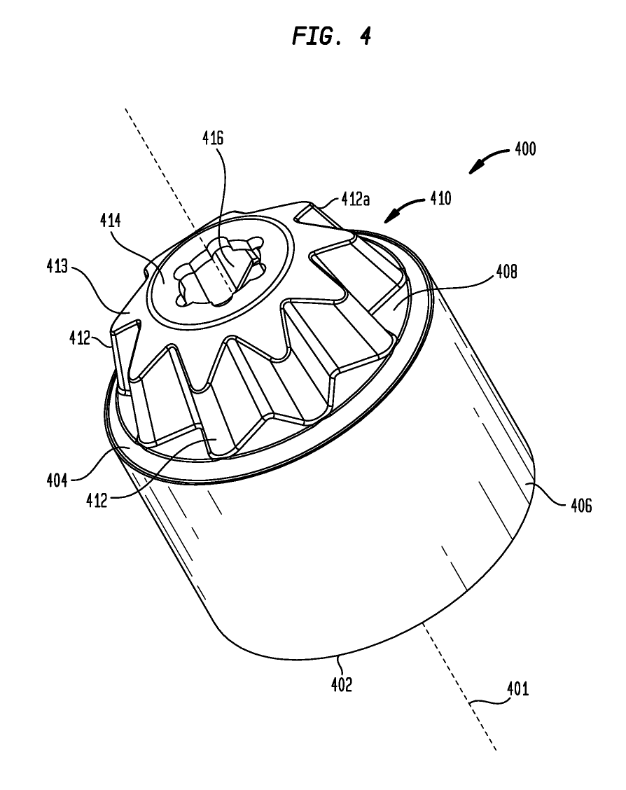

FIG. 4 shows a generally cylindrical drive gear 400 having an axis of rotation 401 in accordance with aspects of the present invention. One end 402 of the generally cylindrical drive gear 400 is adapted to be attached to a hollow roller or generally cylindrical imaging component, such as an OPC drum. The other end 404 of the drive gear 400 is adapted to engage the drive mechanism of a printer. The end 402 of the drive gear 400 includes a body 406 for engaging the generally cylindrical imaging component. The end 404 of the drive gear 400 includes an end surface 408. A drive portion 410 extends longitudinally outward from the end surface 408 and is shaped to engage a recess of the printer drive mechanism. The drive portion 410 comprises a plurality of connected pillars 412, an incline surface 413, and a top surface 414 having an opening 416. A circle circumscribing the tips of the pillars 412 has a greater diameter at the base of the pillars 412 (where the pillars 412 connect to the end surface 408) than at the top of the pillars 412. In other words, the drive portion 410 narrows or tapers towards the axis of rotation 401 of the drive gear 400 as the distance from the end surface 408 increases outward. Each of the pillars 412 may be generally triangular in shape with a vertex 412a of each triangular shaped pillar 412 being generally rounded. The number of pillars 412 may be nine or other suitable numbers for engaging a portion of the recesses of the printer drive mechanism. The incline surface 413 may at least partially slope upwards toward the top surface 414. The opening 416 may comprise a circle or other regular or irregular shape.

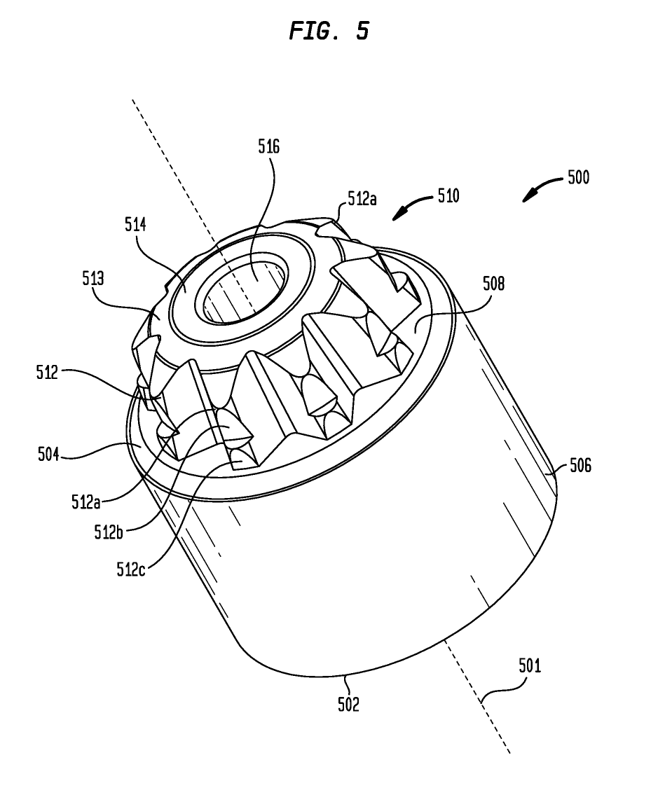

FIG. 5 shows a generally cylindrical drive gear 500 having an axis of rotation 501 in accordance with aspects of the present invention. One end 502 of the generally cylindrical drive gear 500 is adapted to be attached to a hollow roller or generally cylindrical imaging component, such as an OPC drum. The other end 504 of the drive gear 500 is adapted to engage the drive mechanism of a printer. The end 502 of the drive gear 500 includes a body 506 for engaging the generally cylindrical imaging component. The end 504 of the drive gear 500 includes an end surface 508. A drive portion 510 extends longitudinally outward from the end surface 508 and is shaped to engage a recess of the printer drive mechanism. The drive portion 510 comprises a plurality of connected pillars 512, an incline surface 513, and a top surface 514 having an opening 516. A circle circumscribing the tips of the pillars 512 has a greater diameter at the base of the pillars 512 (where the pillars 512 connect to the end surface 508) than at the top of the pillars 512. In other words, the drive portion 510 narrows or tapers towards the axis of rotation 501 of the drive gear 500 as the distance from the end surface 508 increases outward. Each of the pillars 512 may be generally triangular in shape with a vertex 512a of each triangular shaped pillar 512 being generally rounded with one or more steps 512b and 512c. The number of pillars 512 may be nine or other suitable numbers for engaging a portion of the recesses of the printer drive mechanism. The incline surface 513 may at least partially slope upwards toward the top surface 514. The opening 516 may have a jagged as shown or other suitable shape.

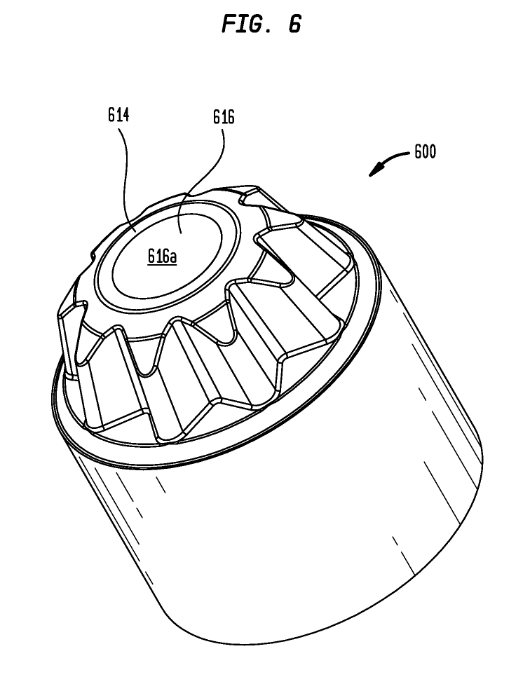

In an alternative embodiment 600, as shown in FIG. 6, a top surface 614 may include a deformable element 616a covering the opening 616. When no pressure is applied to the area 616, the deformable element 616a may be flush with a top 614. When a pressure is applied to the area 616, the deformable element 616a deforms or moves in response to the pressure to allow a portion of the printer drive mechanism to enter the opening 616. The deformable element 616a may comprise rubber, foam, felt material or other suitable material. Alternatively, the deformable element 616a may comprise a solid material backed by a compressible material, such as a spring. Any of the embodiments disclosed herein may comprise the deformable element 616a rather than an uncovered opening 616.

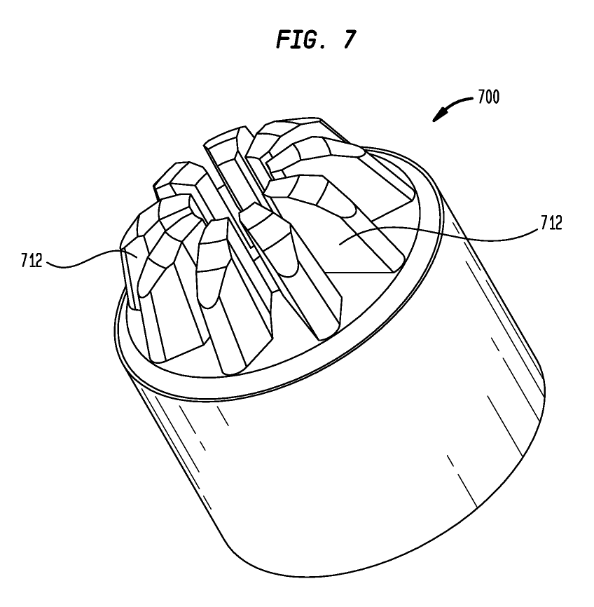

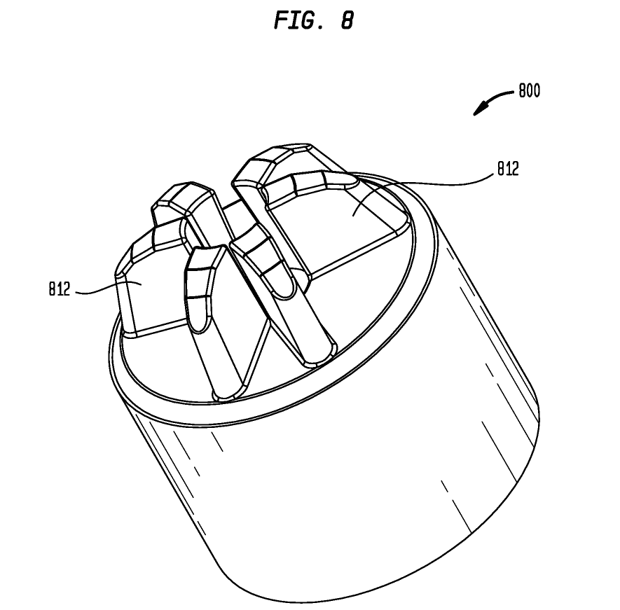

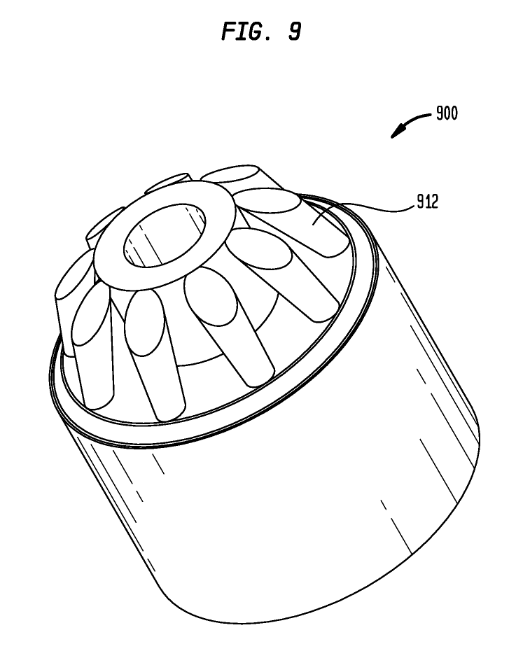

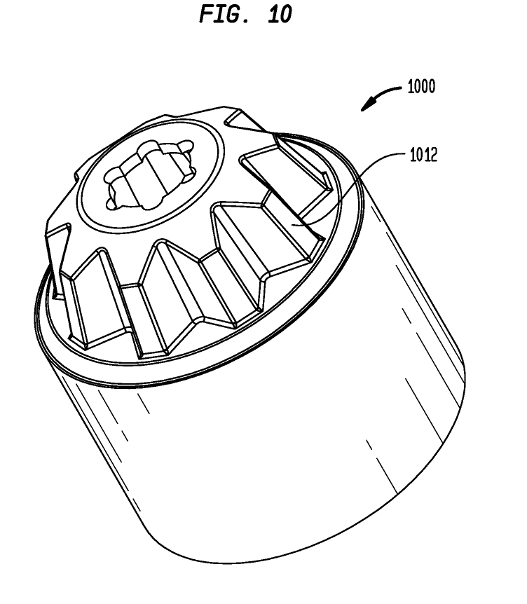

In alternative embodiments 700 and 800, as shown in FIGS. 7 and 8, a top surface is not included and individual pillars 712 and 812 are separated. FIG. 9 shows an alternative embodiment 900 having generally cylindrical pillars 912. FIG. 10 shows an alternative embodiment 1000 have pillars 1012 having a squared or planar apex.

Although specific embodiments have been illustrated and described herein, those of ordinary skill in the art appreciate that any arrangement that is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A drive gear for a generally cylindrical imaging component, the drive gear comprising:
a body for engaging the generally cylindrical imaging component having an axis of rotation;
a drive portion extending out from body along the axis of rotation,
wherein the drive portion comprises a plurality of pillars and narrows towards the axis of rotation of the drive gear as the distance from the end surface increases outward,
wherein the plurality of pillars is greater than three.

2. The drive gear of claim 1 wherein the plurality of pillars is six.

3. The drive gear of claim 2 wherein the six pillars are disposed in three groups of two pillars.

4. The drive gear of claim 3 wherein the distance between the two pillars of each group is less than the distance separating pillars of different groups.

5. The drive gear of claim 1 wherein the drive portion comprises an opening disposed at the center of the pillars along the axis of rotation.

6. The drive gear of claim 5 further comprising a deformable element disposed in the opening.
